(19) United States
(12) Patent Application Publication
(10) Pub. No.: US 2017/0049245 A1
(43) Pub. Date: Feb. 23, 2017

(54) CUSHION FOR SEAT AND METHOD OF FORMING THE SAME

(71) Applicant: TACHI-S CO., LTD., Tokyo (JP)

(72) Inventors: Kazuo NOGUCHI, TOKYO (JP); Jun TAKANO, TOKYO (JP)

(21) Appl. No.: 15/341,516

(22) Filed: Nov. 2, 2016

Related U.S. Application Data
(62) Division of application No. 14/674,419, filed on Mar. 31, 2015.

(30) Foreign Application Priority Data
Mar. 31, 2014 (JP) 2014-073367

(51) Int. Cl. A47C 27/12; B60N 2/64; B29C 51/02; B29C 51/26; B29C 51/00; B29C 51/08

(52) U.S. Cl. CPC A47C 27/12; B29C 51/004; B29C 51/082; B29C 51/02; B29C 51/264; B60N 2/64; B29K 2101/12

(57) ABSTRACT

Organic fibers and inorganic fibers, used as materials, are mixed, thereby forming a web 18. Inter-fiber bonding is then performed on the web, forming a non-woven fabric web. The non-woven fabric web is cut, providing a web piece 18a shaped like a seat pad 30. The web piece is set in a metal mold and then compressed in the metal mold. Next, the metal mold is heated, thereby heating the organic fibers of the web piece, at surface, thereby welding the organic fibers together and molding a seat pad. The seat pad is covered with a trim cover, producing a cushion. The organic fibers are used in mixing ratio of 50% by weight or more, and the inorganic fibers are used in mixing ratio of 50% by weight or less. The organic fibers are made of simple high-molecular substance such as polyethylene fibers.

### CROSS-REFERENCE TO RELATED APPLICATIONS

The present invention claims priority under 35 U.S.C. §119 to Japanese Application No. 2014-073367, filed Mar. 31, 2014, the entire content of which is incorporated herein by reference.

### BACKGROUND OF THE INVENTION

Field of the Invention

This invention relates to a cushion for a seat and a method of forming the cushion for a seat.

Description of the Related Art

The cushion for the seat is widely used in vehicle seats for use in buses, trains, automobiles and aircraft, in seats (office seats) for use in offices, in seats for use in public halls, theaters, movie houses and sport facilities, and in seats for use in households.

A seat of ordinary type has two cushions, i.e., a seat cushion and a seat back cushion. The lower edge of the seat back cushion is coupled to the rear edge of the seat cushion. The seat cushion and the seat back cushion thus constitute the seat.

Each cushion has a pad (seat pad) and a trim cover. The pad is an elastic body made of material rich in elasticity. The trim cover is made of air-permeable material and covers the pad.

The seat pad is a foam body made of foamed material. Since the seat pad is made of foamed material, stress, if any in the seat pad, is hardly be unevenly distributed even if the occupant repeatedly uses the seat, each time sliding his or her buttocks slides on the seat cushion.

As foamed material, urethane foam is widely used. However, urethane foam is considered undesirable in the following respects:
a. Its density is 0.35 to 0.65 g/cm3, and its specific gravity is relatively large, rendering it difficult to reduce the weight of the seat pad.
b. During the molding, it generates isocyanate that is harmful. In order to remove isocyanate, the seat-pad forming machine must be complex in structure.
c. Since urethane is thermosetting material, the seat pad cannot be recycled.

The cushions are known, each having a seat pad made not of foamed material, but of natural material such as cotton, wool or plumes or synthetic fibers such as acryl fibers, polyester fibers or glass fibers. The seat cushion of this type is, however, inferior in elasticity. Further, the natural material or the synthetic fibers may move and may be unevenly distributed, as the seat is repeatedly seated, with the occupant's buttocks sliding on the seat cushion each time.

In this regard, JP 2004-337292A discloses a cushion having a seat pad that is a fiber assembly. The fiber assembly is composed of fibers that are bound together, at contact points, with binding agent, forming a three-dimensional assembly. The fiber assembly is adhered to a first protective sheet. The first protective sheet is covered with a second sheet. The fiber assembly and the first and second protective sheets are quilted together, thus forming the cushion.

In this configuration, the seat pad is a fiber assembly, i.e., a three-dimensional assembly composed of fibers that are bound together, at contact points, by means of a binding agent. The seat pad can therefore acquire high elasticity. In addition, the second protective sheet slides on the first protective sheet adhered to the fiber assembly. Therefore, the seat pad (more precisely, the fiber assembly) would not move even if the seat is repeatedly seated, with the occupant's buttocks sliding on the seat cushion each time. Hence, the stress in the seat pad will hardly be unevenly distributed.

The fibers constituting the fiber assembly (i.e., seat pad) may be natural material such as cotton, hemp or wool, or synthetic fibers such as acryl fibers, aramid fibers, polyester fibers, glass fibers or carbon fibers, or a mixture of these materials. Moreover, the fiber assembly may be composed of fibers of one type, or of fibers of two or more types.

An example of the fiber assembly according to JP 2004-337292A includes 50% by weight or more of carbon fibers, on the basis of the total weight of the fiber assembly. The carbon fibers are bound together, at contact points, with binding agent, and form a three-dimensional assembly. The binding agent may be thermosetting resin such as phenol resin, vinyl ester resin or polyester resin. Further, fire-retardant fibers or non-flammable fibers may be bound together with the carbon fibers (occupying 50% by weight or more), to form the fiber assembly.

JP 2004-337292A specifies that the fibers are bound together, at contact points, with binding agent, forming a fiber assembly used as seat pad. The adhesive is therefore indispensable. Since the adhesive is a thermosetting resin, the seat pad cannot be recycled.

The organic fibers constituting the fiber assembly may be acryl fibers, aramid fibers or polyester fibers. These organic fibers exemplified have relatively high specific densities. If composed of the fibers of one type or the fibers of two or more types, the fiber assembly may not serve to lighten the seat pad. Even if 50% by weight or more of the seat pad is made of carbon fiber, the seat pad can hardly be made light as described.

Accordingly, an object of this invention is to provide a method of forming a cushion for a seat.

Another object of this invention is to provide a cushion for a seat that can be formed without using any binding agent.

### SUMMARY OF THE INVENTION

In this invention of claim 1, a method of forming a cushion for a seat comprises of a step of mixing organic fibers and inorganic fibers, thereby forming a web; a step of performing inter-fiber bonding on the web, thereby forming a non-woven fabric web; a step of cutting the non-woven fabric web, providing a web piece shaped like a seat pad; a step of setting the web piece in a metal mold and then compressing the web piece in the metal mold; a step of heating the metal mold, thus heating the organic fibers of the web piece, at surface, to a temperature equal to or higher than the melting point of the organic fibers, thereby molding a seat pad; a step of opening the metal mold and removing the seat pad from the metal mold; and a step of covering the seat pad with a trim cover.

According to the invention of claim 5, a cushion for a seat comprises of a seat pad produced by mixing organic fibers and inorganic fibers, binding the fibers, thereby forming a web, by cutting the web, providing a web piece having the same shape as the seat pad, and by melting the organic fibers of the web piece; and a trim cover covering the seat pad.

In this invention, the organic fibers are heated, at surface layer, to a temperature higher than their melting point. The organic fibers are thereby thermally fused together. A seat pad can therefore be formed without using any binding agent made of thermosetting resin. Moreover, the seat pad can be recycled since no binding agent made of thermosetting resin is used to bind the organic fibers together.

### BRIEF DESCRIPTION OF THE DRAWINGS

FIG. 1 is a diagram outlining a method of forming the seat pad of a cushion for a seat, according to an embodiment of the present invention.

### DETAILED DESCRIPTION OF THE INVENTION

An embodiment of this invention will be described in detail with reference to the accompanying drawing.

In this invention, organic fibers and inorganic fibers are bound together, forming a seat pad. Then, the seat pad is covered with a trim cover, forming a cushion for a seat.

How the seat pad is formed will be first described.

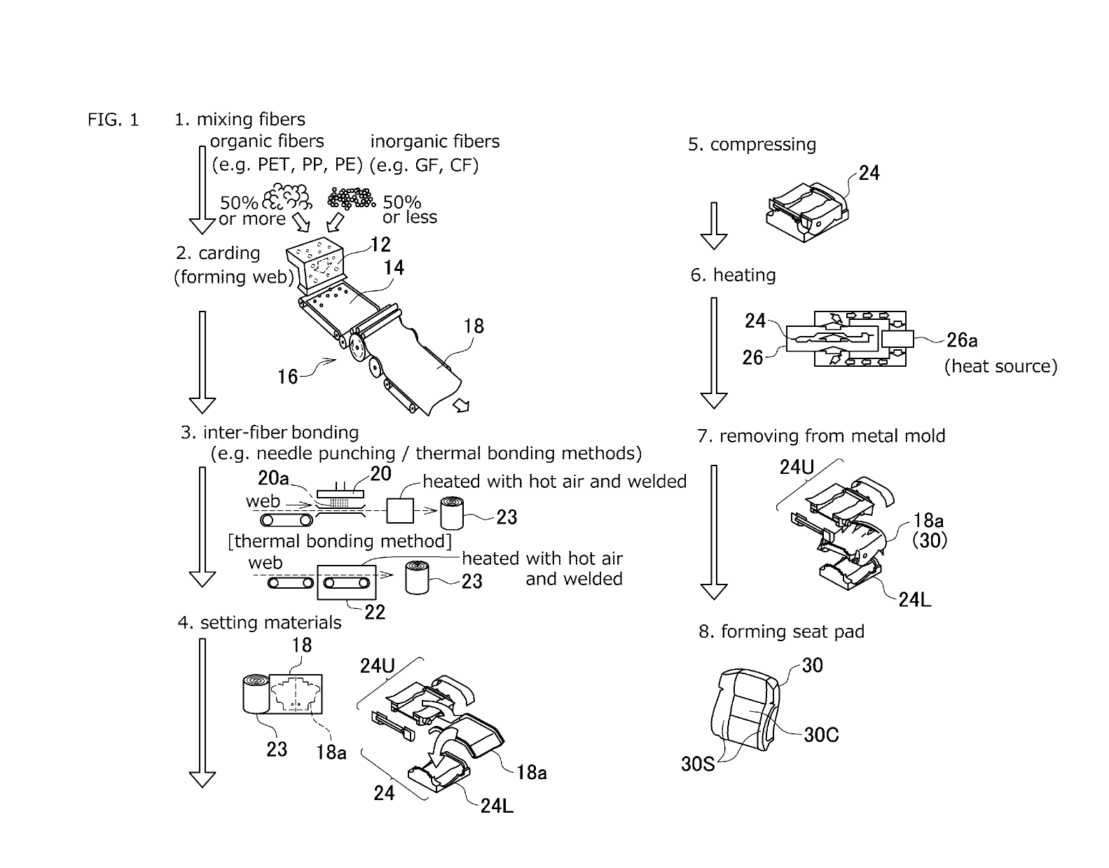

As shown in FIG. 1, organic fibers and inorganic fibers, used as materials, are supplied to a mixing machine 12. The mixing machine 12 mixes the organic fibers and inorganic fibers, producing mixed fibers 14. The organic fibers are used in mixing ratio of 50% by weight or more, and the inorganic fibers are used in mixing ratio of 50% by weight or less.

The organic fibers are selected from various types of fibers specified below:

Polyethylene fibers

Polypropylene fibers

Mixture of polyethylene fibers and polypropylene fibers

Polyethylene terephthalate fibers

Polybutylene terephthalate fibers

Mixture of polyethylene terephthalate fibers and polybutylene terephthalate fibers.

These organic fibers are not bound together with thermosetting resin. The resultant seat pad can therefore be recycled. Further, the organic fibers a. to c. specified above are made of simple high-molecular substances, each composed of only carbon atoms and hydrogen atoms, not having nitrogen atoms, oxygen atoms or benzene rings. This can lighten the seat pad.

The inorganic fibers are selected from, for example, various types of fibers specified below:

Glass fibers

Carbon fibers

Mixture of glass fibers and carbon fibers.

The mixture of the organic fibers and inorganic fibers is taken out from the mixing machine 12 and supplied to a carding machine 16. In the carding machine 16, the mixture is carded, orientating the fibers. The fibers so carded are fed out in a specific direction, forming a sheet-like web (fleece) 18.

Next, the mixed fibers of the web 18 undergo inter-fiber bonding, providing non-woven fabric. The inter-fiber bonding is accomplished by, for example, the needle punching method or the thermal bonding method. In the needle punching method, the web 18 is fed to a needle punching machine 20. In the needle punching machine 20, the needles 20a are repeatedly driven up and down at high speed, each time piercing the web. At this point, the barbs provided on each needle 20a mechanically entangle the mixture fibers, one after another. The fixture fibers are thereby bound together. In the thermal boding method, the web 18 is fed into an oven 22. In the oven 22, the web 18 is heated with hot air, and the fibers are welded together. In the thermal boding method, the fibers may be first mechanically entangled in the needle punching machine 20 and then be heated with hot air and welded together.

Now with the fibers bound together and forming non-woven fabric, the web 18 is taken up in the form of a roll 23. From the roll 23, the web 18 is then fed and cut, providing web pieces 18a having the same shape as a seat pad 30. The web 18 is, for example, 30 to 40 mm thick. If one web piece 18a is too thin for a seat pad, a plurality of web pieces 18a will be overlapped and bound together, to form a seat pad.

Each web piece 18a (cut from the web 18) is set in a metal mold 24 and is compressed. More precisely, the web piece 18a is laid in the lower mold half 24L, and the lower mold half is covered with the upper mold half 24U. In the embodiment, the upper mold half 24U is composed of three parts.

The metal mold 24 is pre-heated. The web piece 18a is thereby heated, at the surface of each organic fiber, to a temperature equal to or higher than the melting point of the organic fibers. Compressed between the upper mold half 24U and the lower mold half 24L, the web piece 18a is heated, acquiring a prescribed shape. In the web piece 18a, the organic fibers are welded together, forming (or molding) a seat pad 30 having the prescribed shape. In the process, the metal mold 24 remains in, for example, a heating furnace 26. In the heating furnace 26, air heated by means of a heat source 26a (hot air) circulates, heating the metal mold 24.

As specified above, the web piece 18a is composed of 50% by weight or more of organic fibers and 50% by weight or less of inorganic fibers. Thus, more organic fibers are mixed with less inorganic fibers. Hence, the organic fibers are welded together more efficiently than otherwise, and any binding agent, such as thermosetting resin, need not be used at all. The seat pad can therefore be recycled.

Then, the metal mold 24 is removed from the heating furnace 26 and cooled. Thereafter, the upper mold half 24U is separated from the lower mold half 24L, thus opening the lower mold half. The seat pad 30 is released from the lower mold half 24L.

The seat pad 30 is so shaped that the seat cushion or seat back cushion appropriately holds the occupant's buttocks or back. In the embodiment, the seat pad 30 is formed as that part of the seat back cushion, which holds the occupant's back. More specifically, the seat pad 30 is composed of a center part 30C and left and right side parts 30S, and thus has a transverse cross section shaped like letter C. The center part 30C may hold the occupant's back, whereas the side parts 30S may hold the occupant's sides to prevent the occupant from moving sideways.

The seat pad 30 is formed of the mixed fibers composed of the organic fibers and the inorganic fibers, as an integral molding. The seat pad 30 so formed is covered with a trim cover (i.e., surface sheet). As a result, a seat back cushion is manufactured.

That is, the seat back cushion comprises a seat pad and a trim cover covering the seat pad. The seat pad has a web piece cut from a web that is composed of organic fibers and inorganic fibers mixed together and subjected to inter-fiber bonding. In the web, the organic fibers are welded one to another, at surface. Of course, the seat cushion can be manufactured by the same method that the seat back cushion is manufactured.

As described above, the seat pad 30 is made of a mixture that is composed of 50% by weight or more of organic fibers and 50% by weight or less of inorganic fibers. The fiber mixture therefore has a low density, and the seat pad 30 is lighter than otherwise. Moreover, since organic fibers are used more than the inorganic fibers, the seat pad 30 is rich in elasticity and less liable to compression strain as it is repeatedly compressed in use.

The fiber mixture may be composed of, for example, 80% by weight of organic fibers and 20% by weight of inorganic fibers.

As has been described, the organic fibers are heated, at surface, to a temperature equal to or higher than their melting point, and are thereby welded together. The seat pad can therefore be formed without using binding agent made of thermosetting resin, and can therefore be recycled.

Some embodiments of the inventions have been described, but are not intended to limit the scope of the inventions. Accordingly, various changes and modifications made without departing from the spirit or scope of the general inventive concept are, of course, all included in the present invention.

This invention is not limited to vehicle seats for use in buses, trains, automobiles and aircraft. Rather, the invention can be applied also to seats (office seats) for use in offices, to seats for use in public halls, theaters, movie houses and sport facilities, and to seats for use in households.

1.-4. (canceled)

5. A cushion for a seat comprising:
a seat pad produced by mixing organic fibers and inorganic fibers, binding the fibers, thereby forming a web, by cutting the web, providing a web piece having the same shape as the seat pad, and by melting the organic fibers of the web piece; and
a trim cover covering the seat pad.

6. The cushion for the seat according to claim 5, wherein the organic fibers are used in mixing ratio of 50% by weight or more, and the inorganic fibers are used in mixing ratio of 50% by weight or less.

7. The cushion for the seat according to claim 6, wherein the organic fibers are selected from any one of the following:
a. polyethylene fibers,
b. polypropylene fibers,
c. mixture of polyethylene fibers and polypropylene fibers,
d. polyethylene terephthalate fibers,
e. polybutylene terephthalate fibers,
f. mixture of polyethylene terephthalate fibers and polybutylene terephthalate fibers.
